(19) United States
(12) Patent Application Publication
(10) Pub. No.: US 2009/0271140 A1
(43) Pub. Date: Oct. 29, 2009

(54) SEMICONDUCTOR DEVICE

(75) Inventor: Yasunori Tashiro, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kawasaki (JP)

(21) Appl. No.: 12/429,581

(22) Filed: Apr. 24, 2009

(30) Foreign Application Priority Data
Apr. 28, 2008 (JP) 2008-117432

(51) Int. Cl. G06F 19/00

(52) U.S. Cl. 702/120

(57) ABSTRACT

Cost of testing is reduced. An SiP (1) comprises an AD chip (2) and a logic chip (3) that perform transmission and reception of data. The AD chip (2) comprises AD conversion circuits (12a and 12b) that generate parallel data, parallel-serial conversion circuits (13a and 13b) that divide parallel data generated by the AD conversion circuits (12a and 12b) and perform time-based sorting, and selection circuits (14a and 14b) that select any of: output data of the parallel-serial conversion circuits (13a and 13b), or divided data obtained by dividing the parallel data so as to enable transmission of each thereof by said plural paths, and output to the logic chip (3). The logic chip (3) comprises serial-parallel conversion circuits (15a and 15b) that recover original parallel data from data sorted in a time-based manner, and a selection circuit (16) that selects: original parallel data obtained by combining the divided data, or original parallel data recovered by the serial-parallel conversion circuits (15a and 15b), and outputs to a terminal (18).

### REFERENCE TO RELATED APPLICATION

This application is based upon and claims the benefit of the priority of Japanese patent application No. 2008-117432, filed on Apr. 28, 2009, the disclosure of which is incorporated herein in its entirety by reference thereto.

### TECHNICAL FIELD

The present invention relates to a semiconductor device, and in particular, to test technology for a semiconductor device in which a plurality of LSI chips are mounted on one package.

### BACKGROUND

In recent years, in semiconductor packages, technologies in which a plurality of LSI chips is included in one package, such as SiP (System in Package) and MCP (Multi Chip Package), are attracting attention. Along with significant development and growth of electronic information devices, digital domestic electrical appliances, and the like, there is increasing demand for more multi-functionality and high performance in LSIs, so that attention is being focused upon SoC (System on Chip) technology that realizes a system on one silicon chip. On the other hand, SiP technology, which conventionally is not superior to the SoC technology from the viewpoint of cost and has not been recognized as mainstream technology, is once again in the spotlight for potential ability to realize a wide variety of system functions in a short time.

When chips are connected in the SiP, it is desirable that the number of connected signal lines be arranged to be as small as possible from the viewpoint of improvement in assembly yield and test efficiency. For example, in cases where an AD chip and a logic chip are in the SiP, if output of an AD converter of n-bit resolution in the AD chip is connected as it is to the logic chip, a data bus is required in which the number of signal lines is n. In order to reduce the number of signal lines of the data bus, a parallel-serial conversion circuit in the AD chip, which is on a transmitting side, synchronizes a sampling clock and an m-multiplied clock thereof to perform parallel-serial conversion of the signal. N-bit digital data is outputted to a data bus of n/m lines, and by a serial-parallel conversion circuit in the logic chip, which is on a receiving side, similarly synchronizing a sampling clock and an m-multiplied clock to return to an original n-bit digital signal, and thus it is possible to reduce the number of transmission-reception signal lines.

This type of device is disclosed in Patent Document 1 as an example of image signal transmission. In an image signal transmission circuit, when an image signal is transmitted via a data bus, in order to reduce the number of signal lines of the data bus, a multiplier circuit multiplies a pixel clock, a parallel-serial conversion circuit synchronizes with a multiplied clock generated by the multiplier circuit, to perform parallel-serial conversion of the image signal, and the image signal, which is a serial signal, is outputted to a database.

A conventional image signal transmission circuit is configured as above, so that it is possible to reduce the number of signal lines of the data bus. However, the multiplier circuit has to multiply the pixel clock to generate the multiplied clock, and power consumption increases. Furthermore, the multiplied clock generated by the multiplier circuit results in clock noise, and there has been a concern that amount of noise in a circuit will increase.

Accordingly, an image signal transmission circuit in which a multiplied clock of the pixel clock is not generated and which reduces the number of signal lines of the data bus is disclosed in Patent Document 2. This image signal transmission circuit divides bit width of a captured image signal into 2, outputs one divided signal to a database when the pixel clock goes to an H level, and outputs the other divided signal to the database when the pixel clock goes to an L level. On a signal receiving side, a configuration is such that one of the divided signals from the data bus is captured at a timing at which the pixel clock falls, and the divided signal is outputted to an output port at a timing at which the pixel clock rises, and the other divided signal from the data bus is captured at a timing at which the pixel clock rises, and this divided signal is outputted to the output port.

### [Patent Document 1]

JP Patent Kokai Publication No. JP-P2004-266745A

### [Patent Document 2]

JP Patent Kokai Publication No. JP-P2006-304088A

### SUMMARY OF THE DISCLOSURE

The entire disclosures of Patent Documents 1 and 2 are incorporated herein by reference thereto.

The following analysis is given by the present invention.

A representative test method for an SiP configured from a plurality of LSI chips includes performing adequate testing on each of the chips before assembly to form the SiP, and testing connectivity between each chip after assembly. At this time, in cases where there are components that cannot adequately be tested in a chip state, by giving consideration at a chip design stage to a circuit that enables testing of the SiP and to reducing the number of connecting signal lines between each chip, it is possible to test the SiP efficiently and at low cost.

According to a conventional configuration it is possible to reduce the number of data bus signal lines. However, when in a test mode, in the device disclosed in Patent Document 1, a high multiplier clock signal is necessary. Moreover, in the device disclosed in Patent Document 2, it is necessary to operate with a clock signal at both a H level and an L level. As a result, a high performance LSI tester, in which special conditions are required in a test clock signal, is necessary, and the cost of testing increases.

According to a first aspect of the present invention, there is provided a semiconductor device comprising a transmitter and a receiver that perform transmission and reception of data. The transmitter includes a number of sets, corresponding to the number of (plural) paths (signal channels). Each set comprises a data generation circuit that generates parallel data, a data sorting circuit that divides the parallel data generated by the data generation circuit and performs time-based sorting; and a first selection circuit that selects any one of: (a) output data of the data sorting circuit, and (b) divided data obtained by dividing the parallel data so as to enable transmission of each thereof through the plural paths, and outputs to the receiver.

The meritorious effects of the present invention are summarized as follows.

According to the present invention, when testing, it is possible to transmit each of parallel data by a plurality of paths, and since a special clock signal is not necessary, testing can be performed by a cheap LSI tester of low speed. Therefore, it is possible to reduce the cost of testing.

### BRIEF DESCRIPTIONS OF THE DRAWINGS

FIG. 1 is a block diagram illustrating a configuration of a semiconductor device according to an exemplary embodiment of the present invention.

### PREFERRED MODES OF THE INVENTION

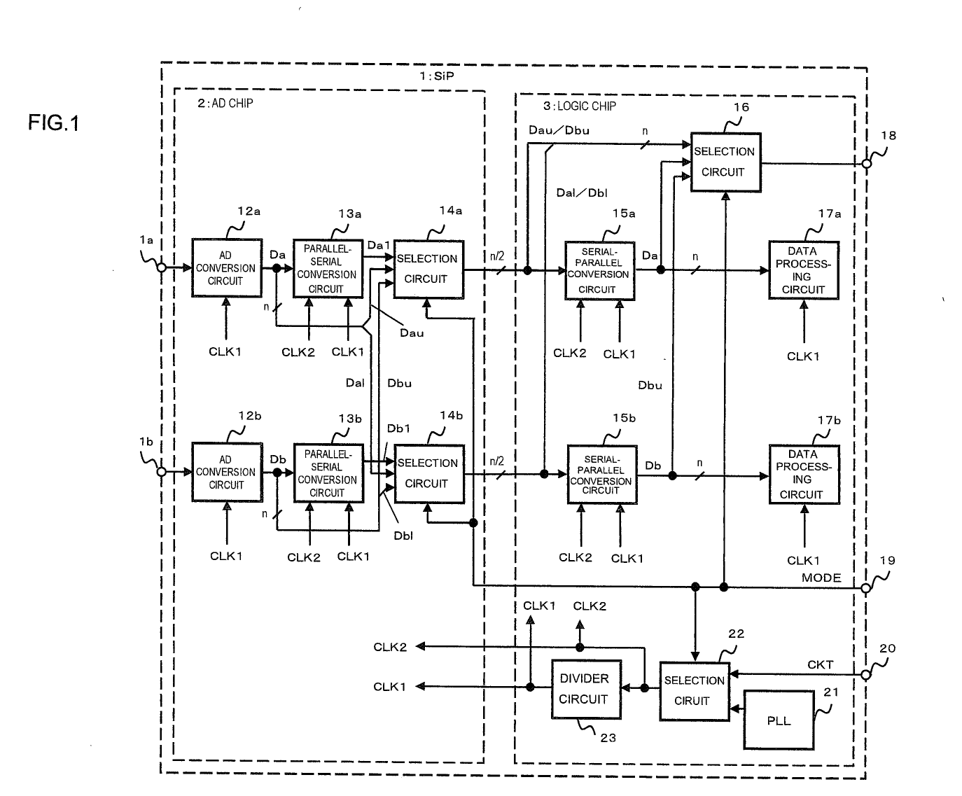

A semiconductor device (corresponding to SiP 1 in FIG. 1) according to an exemplary embodiment of the present invention is provided with a transmitter (corresponding to an AD chip 2 in FIG. 1) and a receiver (corresponding to a logic chip 3 in FIG. 1) that perform transmission and reception of data. The transmitter is provided with a number of sets (2 sets in FIG. 1), corresponding to the number of plural paths, each set comprising of: a data generation circuit (corresponding to AD conversion circuit 12a or 12b in FIG. 1) that generate parallel data; a data a sorting circuit (corresponding to parallel-serial conversion circuit 13a or 13b in FIG. 1) that divides parallel data generated by the data generation circuit and perform time-based sorting; and a first selection circuit (corresponding to selection circuits 14a or 14b in FIG. 1) that select any one of: (a) output data of the data sorting circuits, and (b) divided data obtained by dividing the parallel data so as to enable transmission of each thereof by the plural paths, and output to the receiver.

Moreover, the first selection circuit or circuits, when the semiconductor device is operated in a test mode, preferably selects or select the divided data.

Furthermore, it is preferable that the transmitter outputs output data of the data sorting circuits to the receiver faster than the divided data.

In addition, it is preferable that the receiver is provided with a test output part (AD test output terminal 18 of FIG. 1) that combines the divided data, which was divided according to the plural paths, and enables output with original parallel data.

Moreover, the receiver may be provided with data recovery circuits (corresponding to serial-parallel conversion circuits 15a and 15b of FIG. 1) that recover original parallel data from the data that was sorted in a time-based manner, and a second selection circuit (corresponding to selection circuit 16 of FIG. 1) that selects any one of: (i) the original parallel data obtained by combining the divided data, and (ii) the original parallel data that was recovered by the data recovery circuits; and may enable output of the data selected by the second selection circuit to the test output part.

Furthermore, the second selection circuit, when the semiconductor device is operated in the test mode, may select the original parallel data obtained by combining the divided data.

In addition, the data generation circuits may be AD converters, and the parallel data may be AD converted data.

Furthermore, the receiver may be provided with data processing circuits (corresponding to data processing circuits 17a and 17b of FIG. 1) that process parallel data recovered by the data recovery circuits.

According to the above type of semiconductor device, the number of data bus signal lines between the transmitter and receiver is reduced, and the divided data, which were divided to enable each thereof to be transmitted by the plural paths when a test is performed, are transmitted so that a multiplier clock is not necessary. Therefore, when testing of the semiconductor device is performed, it is possible to curtail required LSI tester power (capability), and test costs can be reduced.

Below exemplary embodiments are described in detail, making reference to the drawings.

### First Exemplary Embodiment

FIG. 1 is a block diagram showing a configuration of a semiconductor device according to a first exemplary embodiment of the present invention. In FIG. 1, the semiconductor device is an SiP 1 in which an AD chip 2, that has 2 channel AD conversion circuits, and a logic chip 3 are included on one package. The SiP 1 is provided with terminals 11a and 11b that receive analog signals, a terminal 18 for test output, a terminal 19 for a test mode selection, and a terminal 20 for receiving a test clock signal.

The AD chip 2 is provided with AD conversion circuits 12a and 12b, parallel-serial conversion circuits 13a and 13b, and selection circuits 14a and 14b. The logic chip 3 is provided with serial-parallel conversion circuits 15a and 15b, selection circuits 16 and 22, data processing circuits 17a and 17b, a PLL 21, and a divider circuit 23.

The AD chip 2 receives analog signals from the terminals 11a and 11b, and receives a selection clock CLK2, a clock signal CLK1 that is a divided clock signal of ½ CLK2, and a test mode selection signal MODE, from the logic chip 3.

The AD conversion circuit 12a performs AD conversion with n-bit resolution using the clock signal CLK1 that is a sampling clock signal, on an analog signal received from the terminal 11a, and outputs parallel data Da of n-bit width. The parallel-serial conversion circuit 13a receives the parallel data Da outputted by the AD conversion circuit 12a, performs parallel-serial conversion with the clock signal CLK1 and the clock signal CLK2, and outputs parallel data Dal that has an n/2 bit width. The selection circuit 14a selects and outputs any of the parallel data Dal, upper bits Dau of the parallel data Da, and upper bits Dbu of parallel data Db, to be described later, based on the test mode selection signal MODE.

The AD conversion circuit 12b performs AD conversion having n-bit resolution with the clock signal CLK1 that is a sampling clock signal, on an analog signal received from the terminal 11b, and outputs parallel data Db of n-bit width. The parallel-serial conversion circuit 13b receives the parallel data Db outputted by the AD conversion circuit 12b, performs parallel-serial conversion with the clock signal CLK1 and the clock signal CLK2, and outputs parallel data Dbl that has an n/2 bit width. The selection circuit 14b selects and outputs any of the parallel data Dbl, lower bits Dal of the parallel data Da described above, and lower bits Dbl of the parallel data Db, based on the test mode selection signal MODE.

The logic chip 3 receives a clock signal CKT for the AD conversion test from the terminal 20 and a test mode selection signal MODE from the terminal 19, and receives n/2 bit width digital data divided in 2 channels, from the AD chip 2. A selection circuit 22 selects an output clock of the PLL 21 for clock generation when in normal operation, by the test mode selection signal MODE, and selects the clock signal CKT received from the terminal 20 when in an AD test mode. The clock signal CLK2 that is output of the selection circuit 22 is outputted to the AD chip 2, and in addition, frequency is divided in two by the divider circuit 23, and its output is supplied to the AD chip 2 as the clock signal CLK1. The clock signal CLK1 is distributed also to the serial-parallel conversion circuits 15a and 15b, and the data processing circuits 17a and 17b, and the clock signal CLK2 is also distributed to the serial-parallel conversion circuits 15a and 15b.

The serial-parallel conversion circuit 15a performs serial-parallel conversion of digital data of n/2 bit width outputted from the selection circuit 14a, by the clock signals CLK1 and CLK2, recovers the original parallel data Da of n-bit width, and outputs to the selection circuit 16 and the data processing circuit 17a. The data processing circuit 17a performs data processing when in normal operation on the recovered parallel data Da.

The serial-parallel conversion circuit 15b performs serial-parallel conversion of digital data of n/2 bit width outputted from the selection circuit 14b, by the clock signals CLK1 and CLK2, recovers the original parallel data Db of n-bit width, and outputs to the selection circuit 16 and the data processing circuit 17b. The data processing circuit 17b performs data processing when in normal operation n the recovered parallel data Db.

The selection circuit 16 selects any of: n-bit width digital data obtained by merging upper and lower positions Dau/Dbu of data outputted from the selection circuits 14a and 14b, the parallel data Da outputted by the serial-parallel conversion circuit 15a, and the parallel data Db outputted by the serial-parallel conversion circuit 15b, according to the test mode selection signal MODE, and outputs to the terminal 18.

In the SiP 1 of the above type of configuration, any of the following (A) normal operation mode, (B) test mode of the AD conversion circuit 12a, and (C) test mode of the AD conversion circuit 12b, is selected, according to the test mode selection signal MODE received from the terminal 19. A description is given below concerning each mode.

In the (A) normal operation mode, the parallel data Da, converted by the AD conversion circuit 12a, is received by the data processing circuit 17a, via the parallel-serial conversion circuit 13a, the selection circuit 14a, and the serial-parallel conversion circuit 15a, and data processing is performed. Furthermore, the parallel data Db, converted by the AD conversion circuit 12b, is received by the data processing circuit 17b, via the parallel-serial conversion circuit 13b, the selection circuit 14b, and the serial-parallel conversion circuit 15b, and data processing is performed.

In the (B) test mode of the AD conversion circuit 12a, an analog signal from the terminal 11a, an AD test clock signal CKT, and the test mode selection signal MODE are received. At this time, with regard to the test mode selection signal MODE, a test mode is selected for the AD conversion circuit 12a. The selection circuit 22 selects the AD test clock signal CKT to provide output as the clock signal CLK2, according to the test mode selection signal MODE. The clock signal CLK2, with frequency being divided into two by the divider circuit 23, is outputted as the clock signal CLK1. The AD conversion circuit 12a, with the clock signal CLK1 as a sampling clock, converts an analog signal received from the terminal 11a into the digital data Da of n-bit width. The digital data Da of n-bit width that has been converted is separated into upper n/2 bits of digital data Dau, and lower n/2 bits of digital data Dal. The upper n/2 bits of data Dau are outputted to the selection circuit 14a, and the lower n/2 bits of data Dal are outputted to the selection circuit 14b. The selection circuit 14a outputs the received upper n/2 bit signal as it is, to the logic chip 3, according to the test mode selection signal MODE, and the selection circuit 14b similarly outputs the received lower n/2 bit signal as it is, to the logic chip 3, according to the test mode selection signal MODE.

The upper n/2 bit data Dau outputted by the selection circuit 14a, and the lower n/2 bit data Dal outputted by the selection circuit 14b are inputted to the selection circuit 16 on the logic chip 3 side. The selection circuit 16 outputs data obtained by merging the upper n/2 bit data Dau and the lower n/2 bit data Dal, that is the data Da, according to the test mode selection signal MODE, to the terminal 18 for test output. An LSI tester, not illustrated in the drawings, is connected to the terminal 18, and tests content of the data Da outputted by the AD conversion circuit 12a.

In the (C) test mode of the AD conversion circuit 12b, similar to operation in the (B) test mode of the AD conversion circuit 12a, data Db outputted by the AD conversion circuit 12b is selected by the selection circuit 16, via the selection circuits 14a and 14b, and outputted to the terminal 18.

As discussed beforehand, in the SiP 1, in which an AD chip 2 having 2 channel AD conversion circuits 12a and 12b, and a logic chip 3 are included on one package, in a case where the number of inter-chip connection signal lines (channels) is reduced, by the parallel-serial and serial-parallel conversion circuits that use a multiplier clock, a clock of frequency double that of an actual operation clock upon testing, is necessary. In contrast to this, in a test mode of the present exemplary embodiment, by bypassing the parallel-serial and serial-parallel conversion circuits, and assigning a data bus of each channel to 1 channel test signal, and separately testing the plural AD conversion circuits 12a and 12b, a multiplier clock signal that is necessary for the normal operation becomes unnecessary.

In a case where, according to the test mode selection signal MODE, the selection circuit 16 selects any of the parallel data Da outputted by the serial-parallel conversion circuit 15a, or the parallel data Db outputted by the serial-parallel conversion circuit 15b, what is referred to as an actual operation test takes place. That is, the AD conversion circuits 12a and 12b operate by a clock signal outputted by the PLL 21, and output AD conversion data to the terminal 18, via the parallel-serial and serial-parallel conversion circuits. In such cases, a test of the AD conversion data in actual operation by the LSI tester is possible.

In the above description, a semiconductor device having 2 channel AD conversion circuits has been described. However, there is no limitation to this, and clearly the semiconductor device may have 3 or more channel AD conversion circuits, and a signal of 1 channel may be divided and assigned to each channel data bus, to individually test the plural AD conversion circuits.

Each disclosure of patent documents and the like as described above is incorporated herein by reference thereto. Modifications and adjustments of embodiments and examples are possible within the bounds of the entire disclosure (including the claims) of the present invention, and also based on fundamental technological concepts thereof. Furthermore, a wide variety of combinations and selections of various disclosed elements are possible within the scope of the claims of the present invention. That is, the present invention clearly includes every type of transformation and modification that a person skilled in the art can realize according to the entire disclosure, including claims, and technological concepts thereof.

It should be noted that other objects, features and aspects of the present invention will become apparent in the entire disclosure and that modifications may be done without departing the gist and scope of the present invention as disclosed herein and claimed as appended herewith. Also it should be noted that any combination of the disclosed and/or claimed elements, matters and/or items may fall under the modification aforementioned.

What is claimed is:

1. A semiconductor device comprising:
a transmitter and a receiver that perform transmission and reception of data; wherein
said transmitter comprises a number of sets, corresponding to the number of paths, each set comprising:
a data generation circuit that generates parallel data;
a data sorting circuit that divides said parallel data generated by said data generation circuit and performs time-based sorting; and
a first selection circuit that selects any one of: output data of said data sorting circuit, and divided data obtained by dividing said parallel data so as to enable transmission of each thereof through said plural paths, and outputs to said receiver.

2. The semiconductor device according to claim 1, wherein said first selection circuit, in case where said semiconductor device is operated in a test mode, selects said divided data.

3. The semiconductor device according to claim 1, wherein said transmitter outputs output data of said data sorting circuit faster than said divided data, to said receiver.

4. The semiconductor device according to claim 2, wherein said transmitter outputs output data of said data sorting circuit faster than said divided data, to said receiver.

5. The semiconductor device according to claim 1, wherein said receiver comprises a test output part that combines said divided data divided corresponding to said plural paths, and enables output as original parallel data.

6. The semiconductor device according to claim 2, wherein said receiver comprises a test output part that combines said divided data divided corresponding to said plural paths, and enables output as original parallel data.

7. The semiconductor device according to claim 5, wherein said receiver comprises:
a data recovery circuit that recovers original parallel data from data that was sorted in a time-based manner; and
a second selection circuit that selects any one of: original parallel data obtained by combining said divided data, and original parallel data recovered by said data recovery circuit; and wherein
output of data selected by said second selection circuit is enabled to said test output part.

8. The semiconductor device according to claim 6, wherein said receiver comprises:
a data recovery circuit that recovers original parallel data from data that was sorted in a time-based manner; and
a second selection circuit that selects any one of: original parallel data obtained by combining said divided data, and original parallel data recovered by said data recovery circuit; and wherein
output of data selected by said second selection circuit is enabled to said test output part.

9. The semiconductor device according to claim 7, wherein said second selection circuit, when said semiconductor device is operated in test mode, selects original parallel data obtained by combining said divided data.

10. The semiconductor device according to claim 7, wherein said data generation circuit comprises an AD converter, and said parallel data is AD converted data.

11. The semiconductor device according to claim 7, wherein said receiver comprises a data processing circuit that processes parallel data recovered by said data recovery circuit.

12. The semiconductor device according to claim 1, wherein said number is selected from 2, 3 or more.

13. The semiconductor device according to claim 1, wherein said number is 2.
